(19) United States
(12) Patent Application Publication
(10) Pub. No.: US 2018/0208012 A1
(43) Pub. Date: Jul. 26, 2018

(54) VEHICLE WITH ADJUSTABLE DAMPERS AND CONTROL METHOD THEREFOR

(71) Applicant: GM GLOBAL TECHNOLOGY OPERATIONS LLC, Detroit, MI (US)

(72) Inventor: Mathias Molitor, Geisenheim (DE)

(73) Assignee: GM GLOBAL TECHNOLOGY OPERATIONS LLC, Detroit, MI (US)

(21) Appl. No.: 15/876,460

(22) Filed: Jan. 22, 2018

(30) Foreign Application Priority Data
Jan. 20, 2017 (DE) 102017000506.0

(51) Int. Cl. B60G 17/016; B60G 17/018; B60G 17/019; B60W 10/20; B60W 30/045; B60W 20/15

(52) U.S. Cl. CPC B60G 17/0164; B60G 17/0182; B60G 17/019; B60W 10/20; B60G 2500/10; B60W 20/15; B60W 2540/18; B60G 2400/41; B60W 30/045

(57) ABSTRACT

The stiffness of dampers for wheels on the front and rear axles are selectively controlled with a control unit. The control unit is configured to detect if the vehicle travels in a curve. In the case of a tendency of the vehicle to understeer, the control unit adjusts the damper of the wheel of the front axle located on the curve outside harder than the damper of the wheel of the front axle located on the curve inside. In the case of a tendency of the vehicle to oversteer, the control unit adjusts the damper of the wheel of the front axle located on the curve inside harder than the damper of the wheel of the front axle located on the curve outside.

### CROSS-REFERENCE TO RELATED APPLICATION

This application claims priority to German Patent Application No. 10 2017 000 506.0, filed Jan. 20, 2017, which is incorporated herein by reference in its entirety.

### TECHNICAL FIELD

The present disclosure pertains to a vehicle with a chassis including a front and rear axle, each axle having with two wheels and controllable dampers assigned to the wheels, as well as a method for controlling the stiffness of the dampers of such a vehicle.

### BACKGROUND

DE 10 2012 223 984 A1 discloses a vehicle having a control unit configured to soft adjust dampers of a front axle soft, but har adjust dampers of a rear axle hard in order to increase the tendency to oversteer the vehicle and in this way bring about a rapid transition of the vehicle from straight-ahead travelling to cornering. Conversely, on leaving the curve, to har adjust dampers of the front axle and soft adjust dampers of the rear axle soft in order to bring about a tendency to oversteer and thereby facilitate returning to the straight-ahead motion. According to this publication, deviations between the steering angle set by the driver and the trajectory of the vehicle resulting from the same are thus accepted and even specifically promoted so that for the driver the unambiguous relationship between set steering angle and curvature of the vehicle trajectory resulting from this is lost.

### SUMMARY

The present disclosure provides a vehicle with which tendencies to over or understeer can be effectively suppressed and thus an unambiguous relationship between steering angle and curvature of the vehicle trajectory that is predictable for the driver is retained even under critical conditions.

According to a configuration of the present disclosure, a vehicle includes a chassis including front and rear axles, each axle having two wheels on different sides of the chassis. A controllable damper is assigned to each wheel in communiction with a control unit configured to control the dampers. When in a cornering manuever such that the vehicle tends to oversteer, the control unit is configured to adjust the damper of the wheel of the front axle located on the curve outside harder than the damper of the wheel of the front axle located on the curve inside and to adjust the damper of the wheel of the rear axle located on the curve outside softer than the damper on the wheel of the rear axle located on the curve inside.

Here, the fact is utilized that the centrifugal acceleration that occurs during cornering tends to shift the vehicle weight from the wheels of the curve inside to those of the curve outside. In order for the vehicle to be able to follow the curve, this centrifugal acceleration has to be offset by forces from the road acting on the wheels and which are directed towards the curve center point. Based on the center of gravity of the vehicle, these forces generate turning moments. The forces acting on the wheels of the front axle drive the yawing motion of the vehicle that is connected with the cornering. By adjusting the curve-outside wheel on the front axle harder than the inside wheel, the road holding of the vehicle, which because of its greater loading can exert greater force inducing a yaw moment on the vehicle than the wheel on the curve inside, is improved. A yaw moment increased in this way counteracts the understeer.

Conversely, the radial forces on the wheels of the rear axle generate a turning moment that counteracts the yaw moment on the vehicle. By adjusting the wheel on the curve outside on the rear axle that is subjected to greater load softer than the one on the inside, its road holding is reduced so that the yaw moment which the wheels of the rear axle exert on the vehicle, becomes smaller than with the same setting on both sides.

It can be easily followed that the effect is greatest when an adjustment of the dampers according to the present disclosure is simultaneously preformed on the wheel of the front and rear axle. Such an adjustment may be carried out such that the dampers of the front outside and of the rear inside wheel are adjust to a same, low hardness and the dampers of the front inside and of the rear outside wheel are adjusted to a same high hardness. It is also conceivable to link the present disclosure with the teaching of DE 10 2012 223 984 A1, in that on the front axle the outside damper is adjusted softer than the one on the inside and on the rear axle the outside damper is adjusted harder than the one on the inside, but the dampers of the front axle on average are simultaneously adjusted softer than those of the rear axle.

Vehicles with rear wheel drive generally have a tendency to oversteer. For this reason, according to a simple configuration of the present disclosure, such a tendency can always be assumed with such vehicles whenever cornering or at least whenever an engine torque acts on the rear axle during cornering.

Analogously to what was described above, a second configuration of the present disclosure provides a vehicle having a chassis including front and rear axle, each axle having two wheels on different sides of the chassis. A controllable damper is associated with each wheel and a control unit controls the dampers. The control unit is configured during cornering in the case of a tendency of the vehicle to oversteer, to adjust the damper of the wheel of the front axle located on the curve inside harder than the damper of the wheel of the front axle located on the curve outside and/or to adjust the damper of the wheel of the rear axle located on the curve inside softer than the damper of the wheel of the rear axle located on the curve outside.

Vehicles with front wheel drive generally have a tendency to oversteer. For this reason, according to a simple configuration of the present disclosure, such a tendency can be assumed with such vehicles whenever cornering or at least whenever engine torque acts on the front axle during cornering.

In particular when there is no engine torque, i.e. when the vehicle rolls without drive, the type of the drive can have no affect on the tendency of the vehicle to over or understeer. In order to be able to adequately steer the dampers also in such a case, the control unit is equipped to take a decision with each individual cornering whether oversteer or understeer is present, and in each case adjust the stiffness of the dampers accordingly.

For this purpose, a steering angle sensor may be arranged on a steering mechanism of the vehicle and the control unit is equipped to take action based on a steering angle of the steering detected by the steering angle sensor.

Furthermore, an acceleration sensor for detecting a lateral acceleration can be in communication with the control unit and the control unit is configured to take the decision based on the detected lateral acceleration.

A further configuration, a yaw rate sensor which detects a yaw rate of the vehicle is connected to the control unit. The control unit is configured to utilize the detected yaw rate for the decision.

The control unit, furthermore, may be configured to take the decision based on data of a navigation device. Such a decision can be taken even before the commencement of the cornering so that an adaptation of the dampers to a curve can take place even before the vehicle enters the curve.

A comparison of representative parameters obtained in various ways makes it possible for the control unit to draw a conclusion regarding current understeer or oversteer of the vehicle and a control of the dampers based on this conclusion.

For adapting to different curve radii or vehicle speeds when travelling through the curve, the difference of the stiffnesses of the dampers of the front and/or rear axle can be a multivalent function of the lateral acceleration.

In particular, a proportionality parameter, which links the difference of the stiffnesses to the lateral acceleration can be adjustable. Such an adjustment can be performed at the factory in order to adapt a control unit used in vehicles of different types to different tendencies to understeer or oversteer of the vehicle types. However, an adaptation of the function by the control unit itself may be based on measurements of the understeer or oversteer of the vehicle.

According to a further configuration of the present disclosure, a method is provided to control the stiffness of dampers of a vehicle, which includes front and rear axles, each axle with two wheels on different sides of the chassis and a controllable damper assigned to each wheel. In accordane with the method, the vehicle is monitored to determine if a cornering event is occuring. If a corning event is detected, and the vehicle has a tendency to understeer, the control unit adjusts the damper of the wheel of the front axle located on the curve outside harder than the damper of the wheel of the front axle located on the curve inside and/or adjusts the damper of the wheel of the rear axle located on the curve outside softer than the damper of the wheel of the rear axle located on the curve outside. In the alternative, if a cornering event is detect and the vehicle has a tendency to oversteer, the control unit adjusts the damper of the wheel of the front axle located on the curve inside harder than the damper of the wheel of the front axle located on the curve outside and/or adjusts the damper of the wheel of the rear axle located on the curve inside softer than the damper of the wheel of the rear axle located on the curve inside.

The present disclosure further provides a computer program product which includes instructions which when executed on a computer enable the same to operate as control unit in a vehicle as described above or to carry out the method defined above, a computer-readable data carrier, on which instructions are recorded, which enable a computer to operate in the manner described above, and a control unit for a vehicle having a chassis including a front and a rear axle each with two wheels on different sides of the chassis, wherein each wheel is assigned a controllable damper. The control unit is configured to detect when the vehicle is cornering, and to adjust the damper of the wheel of the front axle located on the curve outside softer than the damper of the wheel of the front axle located on the curve inside and/or in order to adjust the damper of the wheel of the rear axle located on the curve outside harder than the damper of the wheel of the rear axle located on the curve outside, and/or to adjust the damper of the wheel of the front axle located on the curve inside softer than the damper of the wheel of the front axle located on the curve outside and/or adjust the damper of the wheel of the rear axle located on the curve inside harder than the damper of the wheel of the rear axle located on the curve inside.

### BRIEF DESCRIPTION OF THE DRAWINGS

The present disclosure will hereinafter be described in conjunction with the following drawing figures, wherein like numerals denote like elements.

FIG. 1 is a block diagram of a vehicle according to the present disclosure;

FIG. 2 is a flow diagram of a working method carried out by a control unit of the vehicle; and

FIG. 3 provides examples for possible relationships between lateral acceleration and damper adjustment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

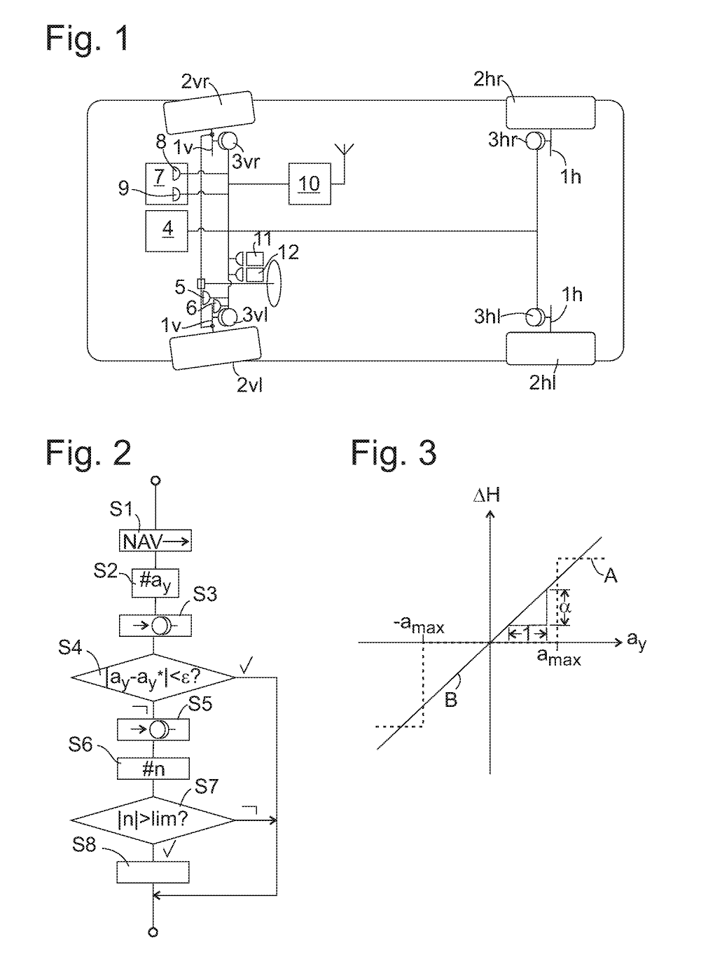

FIG. 1 shows in a schematic plan view a motor vehicle with a front axle 1v and front wheels 2vl, 2vr as well as a rear axle 1h and rear wheels 2hl, 2hr. The front wheels 2vl, 2vr are steerable in the usual manner and are shown in a position adjust for travelling along a left hand curve. Each wheel 2vl, 2vr, 2hl, 2hr is assigned a damper 3vl, 3vr, 3hl and 3hr respectively. The stiffness of the dampers 3vl, 3vr, 3hl, 3hr is adjustable by a control unit 4. During straight-ahead driving, the stiffness at least of the dampers 3vl, 3vr, 3hl, 3hr arranged on a same axle, preferentially the stiffness of all four dampers, is the same among one another.

The control unit 4 is connected to a steering angle sensor 5 which is positioned in any suitable location in the steering of the vehicle in order to supply a representative measurement quantity for the steering angle of the wheels 2vl, 2vr and thus also for the radius of a curve travelled with this steering angle.

The control unit 4, furthermore, is connected to a speedometer 6 in order to estimate the extent of the over or understeer of the vehicle by way of the radius of the curve and the speed of the vehicle. In the simplest case, this estimate can be based on tables empirically determined by a prototype of the vehicle and stored in the control unit. Since this type of estimate does not make possible taking into account interference influences such as for example wind, road condition etc., additional further sensors are utilized according to preferred configurations for the estimation. FIG. 1 shows as part of an ESC (electronic stability control) system 7 an inertial acceleration sensor 8, which supplies a measurement value of the acceleration acting in vehicle lateral direction to the control unit. If the same is smaller than expected for a circular motion on a path with the radius estimated by the steering angle sensor 5 with the speed measured by the speedometer 6, then the vehicle understeers. If the same is higher, this allows concluding oversteer. In both cases, the under or oversteer can be counteracted by a control of the dampers as described in the following by way of FIG. 2.

Alternatively or complementarily, an inertial yaw rate sensor 9 can be provided, which directly supplies the yaw rate of the vehicle. In the case of an ideal control, this measured yaw rate would have to correspond with the angular velocity, with which the vehicle moves with respect to the center point of the curve. If it is higher, oversteer is present, if it is lower, the vehicle understeers.

Furthermore, a navigation system 10 can be in commuication with the control unit 4 in order to report to the same the radius of a curve located directly ahead. Based on this radius and a current or extrapolated speed, the control unit 4 can adapt the stiffness of the dampers even before reaching the curve so that under or oversteer is expected to be avoided.

A working method of the control unit 4 is explained by way of the flow diagram of FIG. 2. It is assumed that at the start of the method the vehicle moves straight ahead. All dampers 3vl, 3vr, 3hl, 3hr are adjusted to the same stiffness.

In the case that the navigation system 10 is connected, the control unit receives in step 51 information from the navigation system 10 regarding direction and radius r of the curve before entering a curve. In step S2, a lateral acceleration ay according to the formula ay=v2/r is estimated when travelling through the curve. As speed v the speed measured by the speedometer 6 at the time of the calculation or when an accelerator pedal 11 or brake pedal 12 is actuated, a speed extrapolated by the measured speed and the extent of the pedal actuation can be utilized.

By way of the estimated lateral acceleration ay, the stiffness of the dampers 3vl, 3vr, 3hl, 3hr is adapted in step S3. In the simplest case, when the dampers can be switched over only between two discrete stiffnesses, an acceleration limit value amax is determined as a function of the extent of the accelerator pedal actuation. If the estimated lateral acceleration ay remains below the acceleration limit value amax, the stiffnesses of the dampers 3vl, 3vr, 3hl, 3hr remain the same among one another. When the estimated lateral acceleration ay exceeds the acceleration limit value, a tendency to oversteer is assumed in a vehicle with front wheel drive, and in order to counteract the same, the curve inside damper of the front axle is adjusted soft and the curve outside damper hard; on the rear axle, the curve inside damper 3hl or 3hr is adjusted hard and the one on the outside soft, so that dampers 3vr, 3hl and 3vl, 3hr adjusted identically in each case are located diagonally opposite one another on the vehicle.

Conversely, in the case of a vehicle with rear wheel drive, a tendency to understeer is assumed when the acceleration limit value is exceeded. In this case, the curve inside damper of the front axle is adjusted hard and the curve outside one soft; on the rear axle, the curve inside damper 3hl or 3hr is adjusted soft and the one on the outside hard.

In the case that more than two values of the stiffness are adjustable, the curve inside dampers can also be adjusted to the same, medium stiffness while in the case of a vehicle with front wheel drive only the curve outside on the damper on the front axle are adjusted hard and the curve outside damper on the rear axle soft and in the case the vehicle with rear wheel drive the curve outside damper on the front axle is adjusted soft and the curve outside damper on the rear axle hard.

The dampers 3vl, 3vr, 3hl, 3hr may be adjustable to a multiplicity of stiffness values. In this case, the difference between the stiffnesses of the dampers of a same axle can be predetermined as a—preferrably continuous or quasi-continuous—function of the estimated lateral acceleration ay, for example the differential AH between the stiffnesses of the dampers of a same axle can be adjusted with a predetermined proportionality factor linearly proportionally to the estimated lateral acceleration ay. As a quantitative measure for the stiffness H for example the speed with which a damper yields to a predetermined force can be assumed here.

FIG. 3 shows examples of such functions. The curve air can be realised with binary adjustable dampers. ΔH is positive (the right damper is stiffer than the left one), when the lateral acceleration ay is directed to the right and its amount is greater than amax; it is negative when the lateral acceleration ay with the amount >amax is directed to the left. The curve B is the differential ΔH directly proportional to ay with a proportionality factor α.

The curves A, B can be used for the dampers 3vl, 3vr of the front axle 1v in order to counteract oversteer or for the dampers 3hl, 3hr of the rear axle 1h in order to counteract understeer. Mirror-image curves are used as a base for the control of the dampers of the respective other axle.

In the case that the control unit 4 does not receive any information from the navigation system 10, for example in the case that no coupling between control unit 4 and navigation system 10 is provided in a simplified configuration of the present disclosure, the steps S2, S3 must be omitted.

When the vehicle is located in the curve, the control unit, in step S4, compares the lateral acceleration ay* measured by the sensor 8 with ay and/or the yaw rate Ψ* measured by the sensor 9 with a value Ψ expected in each case at the current speed and the current steering angle of the wheels 2vl, 2vr. When the deviation between measured and expected value does not exceed a predetermined tolerance limit ϵ the adjustment of the dampers is correct and remains unchanged until the method is repeated.

When the measured lateral acceleration ay* or yaw rate Ψ* is below or above the expected value ay or Ψ by more than the tolerance limit Ω, understeer or oversteer behaviour of the vehicle can then be concluded. The measures of the control unit in this case (S5) correspond to those described with respect to step S3, wherein the measured lateral acceleration takes the place of the estimated lateral acceleration ay.

The measurement S4 and if applicable the damper adjustment S5 can be periodically repeated in order to counteract understeer or oversteer only if required when it occurs while travelling through the curve.

When an adjustment of the dampers has been performed in step S3 even before entering a curve and a further adjustment takes place in step S5 while travelling through the curve, the adjustment of the step S3 has obviously not been commensurate. In order to counteract this, it can be determined in step S6 if there is a systematic error. Such determination can be based for example on an index value n which is incremented every time a step S5 has been carried out on the account of an understeer behaviour, and decremented every time step S5 was carried out because of oversteer behaviour and in step S4 multiplied in each case by a factor <1. If this index value n exceeds an upper limit, the adjustment of the step S3 results in systematic understeer; if it falls below a lower limit, systematic understeer is present. Step S7 therefore compares |n| with a limit value, and when the same is exceeded, an adaptation of the regulation that is used in step S3 is carried out in step S8 in order to control the stiffness of the dampers as a function of the lateral acceleration ay.

When for example the curves of FIG. 3 have been applied in step S3 to the dampers 3vl, 3vr of the front axle 1v in order to counteract oversteer, and in S7 systematic oversteer is nevertheless detected, the adaptation in the case of the curve α can consist in a decrementation of amax, in the case of the curve B in an incrementation of α. If by contrast systematic understeer is detected, the adjustment of the dampers performed in step S3 has obviously been exaggerated; in this case, amax is incremented or a is decremented.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A vehicle comprising:
a chassis having front and rear axles, each axle including two wheels on different sides of the chassis and having a controllable damper for each wheel; and
a control unit configured to control the dampers when the vehicle is travelling through a curve;
wherein the control unit adjusts a damper of the wheel of the front axle located on the curve outside harder than the damper of the wheel of the front axle located on the curve inside when the vehicle understeers in the curve.

17. The vehicle according to claims 16, wherein the control unit is configured to adjust the damper of the wheel of the rear axle located on the curve outside softer than the damper of the wheel of the rear axle located on the curve inside.

18. The vehicle according to claim 16, further comprising an engine in driving engagement with the front axle to provide a drive torque through the front wheels such that the vehicle tends to understeer through the curve.

19. A vehicle comprising:
a chassis having front and rear axles, each axle including two wheels on different sides of the chassis and having a controllable damper for each wheel; and
a control unit configured to control the dampers when the vehicle is travelling through a curve;
wherein the control unit adjust the damper of the wheel of the front axle located on the curve inside harder than the damper of the wheel of the front axle located on the curve outside when the vehicle oversteers in the curve.

20. The vehicle according to claims 19, wherein the control unit is configured to adjust damper of the wheel of the rear axle located on the curve inside softer than the damper of the wheel of the rear axle located on the curve outside.

21. The vehicle according to claim 19, further comprising an engine in driving engagement with the rear axle to provide a drive torque through the rear wheels such that the vehicle tends to oversteer through the curve.

22. The vehicle according to claim 19, wherein the control unit is further configured to take a decision by way of at least one parameter of the curve as to whether oversteer or understeer of the vehicle is present for adjusting the stiffness of the dampers accordingly.

23. The vehicle according to claim 22, further comprising a steering angle sensor arranged on a steering component of the vehicle, wherein the control unit is configured to take the decision by way of a steering angle of the steering detected by the steering angle sensor.

24. The vehicle according to claim 22, further comprising an acceleration sensor in communication with the control unit and configured to detect a lateral acceleration, wherein the control unit takes a decision based on the detected lateral acceleration.

25. The vehicle according to claim 22, further comprising a yaw rate sensor in communication with the control unit and configured to detect a yaw rate of the vehicle, wherein the control unit takes a decision based on the detected yaw rate.

26. The vehicle according to claim 22, further comprising a navigation device in communication with the control unit, wherein the control unit takes a decision base acquired from the navigation device.

27. The vehicle according to claim 22, wherein the control unit is configured to apply a stiffness differential between the dampers of the front rear axles which is a multivalent function of a lateral acceleration.

28. The vehicle according to claim 27, wherein the multivalent function comprises a proportionality parameter adjusting the differential stiffness with the lateral acceleration.

29. The vehicle according to claim 22, wherein the control unit is configured to detect an oversteer or understeer condition and adapt the function based on the oversteer or understeer condition.
